(19) United States
(12) Patent Application Publication
(10) Pub. No.: US 2022/0083389 A1
(43) Pub. Date: Mar. 17, 2022

(54) AI INFERENCE HARDWARE RESOURCE SCHEDULING

(71) Applicant: Nutanix, Inc., San Jose, CA (US)

(72) Inventors: Gaurav Poothia, Remond, WA (US); Sandeep Reddy Goli, San Jose, CA (US); Deepak Muley, San Jose, CA (US); Pranav Desai, San Jose, CA (US)

(73) Assignee: Nutanix, Inc., San Jose, CA (US)

(21) Appl. No.: 17/350,636

(22) Filed: Jun. 17, 2021

Related U.S. Application Data
(60) Provisional application No. 63/079,223, filed on Sep. 16, 2020.

(51) Int. Cl. G06F 9/50; G06N 20/00; G06N 5/04

(52) U.S. Cl. CPC G06F 9/5044; G06F 9/5038; G06N 5/04; G06N 20/00

(57) ABSTRACT

Systems and methods described herein generally relate to compute node resource scheduling. AI inference services described herein may receive a request to execute a machine learning model in a clustered edge system. To determine which hardware resource comprising computing nodes of the clustered edge system on which to execute the machine learning model, AI inference services may compare the computational workload of the machine learning model, with the computational abilities and functions of the hardware resources. In examples, the comparison is based on a scheduling algorithm, including an identification stage to identify candidate hardware resources capable of executing the machine learning model, and a scoring stage to select the best candidate hardware resource for executing the machine learning model. A scheduler may assign the machine learning model to the selected hardware resource for execution by the AI inference services.

### CROSS-REFERENCE TO RELATED APPLICATION(S)

This application claims the benefit under 35 U.S.C. § 119 of the earlier filing date of U.S. Provisional Application Ser. No. 63/079,223 filed Sep. 16, 2020 the entire contents of which are hereby incorporated by reference in their entirety for any purpose.

### TECHNICAL FIELD

The present disclosure relates generally to systems and methods for compute node resource scheduling. Examples of assigning and/or scheduling a machine learning model to an identified candidate hardware resource of a compute node in a clustered computing system using an AI inference service are described.

### BACKGROUND

Internet of Things (IoT) systems are increasing in popularity. Generally, IoT systems utilize a number of edge devices. Edge devices may generally refer to computing systems deployed about an environment (which may be a wide geographic area in some examples). The edge devices may include computers, servers, clusters, sensors, appliances, vehicles, communication devices, etc. Edge systems may obtain data (including sensor data, voice data, image data, and/or video data, etc.). While edge systems may provide some processing of the data at the edge device, in some examples, edge systems may be connected to a centralized analytics system (e.g., in a cloud or other hosted environment). The centralized analytics system, which may itself be implemented by one or more computing systems, may further process data received from edge devices by processing data received by individual edge devices and/or by processing combinations of data received from multiple edge devices.

Machine learning (ML) models have become increasingly implemented as a tool to process data, but are oftentimes resource-intensive by consuming significant compute resources. In IoT systems, deploying ML model applications to run on an edge device may impact performance of the edge system due their prohibitive consumption of compute resources on resource-limited compute nodes. In some examples, edge systems may include hardware accelerators that can be leveraged to execute the ML model. However, in large IoT systems, deployed edge systems may have a wide array of different hardware capabilities and configurations. Thus, determining which node and which hardware accelerator on which to schedule a ML model to run efficiently within a given edge system may be increasingly complicated.

### BRIEF DESCRIPTION OF THE DRAWINGS

Reference is now made to the following descriptions taken in conjunction with the accompanied drawings, in which:

FIG. 1 illustrates a computing system that implements an AI inference service, arranged in accordance with examples described herein;

FIG. 2 is a flow diagram for hardware resource scheduling using an AI inference service, arranged in accordance with examples described herein; and

FIG. 3 is an example block diagram of components of a computing node 300, arranged in accordance with examples described herein.

### DETAILED DESCRIPTION

Certain details are set forth herein to provide an understanding of described embodiments of technology. However, other examples may be practiced without various ones of these particular details. In some instances, well-known computing system components, virtualization components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented herein.

Machine learning model deployment on edge, and at scale, is becoming an increasingly difficult task as machine learning models become more complex. A frequent limitation of implementing machine learning models on and/or within an edge system is the prohibitive computational cost of executing the models on compute resource-constrained hardware within a compute resource-constrained system. For example, neural nets are often deep, meaning that training and using them for inference requires significant compute power. Additionally, many machine learning models rely on graphical processing units (GPUs), which are also scarce and expensive, which adds additional barriers for machine learning model deployment within edge systems. Moreover, in some examples, kubernetes (k8) may not allow the sharing of hardware resources (e.g., GPUs, CPUs, etc.) across containers and/or pods, and oftentimes access to a shared hardware accelerator may not be controlled.

The present disclosure generally relates to systems and methods for scheduling a machine learning model to hardware resources based on an AI inference service, communicatively coupled to a scheduler, by comparing the computational workload of the machine learning model with the computational abilities and functions of hardware resources comprising computing nodes in a clustered computing system. In some examples, this disclosure relates to a distributed and/or clustered computing system which may be used to implement an Internet of Things (IoT) system. Examples of assigning a machine learning model to a selected identified candidate hardware resource of a plurality of identified hardware resources of a compute node in a clustered computing system using an AI inference service are described.

In one non-limiting example, a user, administrator, customer, client, or the like of an edge system may desire to run a machine learning model on computer hardware located within the edge system. Upon receiving the request to run the machine learning model, an AI inference service, communicatively coupled to a scheduler, may identify candidate hardware resources, from a plurality of hardware resources, capable of executing the machine learning model. In some examples, the AI inference service may identify candidate hardware resources, from the plurality of hardware resources, based on analyzing compute resource metrics of the machine learning model to determine an approximate compute resource need to run the machine learning model. To select which hardware resource from the identified candidate hardware resources on which to schedule the machine learning model, AI inference service may, using a scoring algorithm, calculate (e.g., determine) a score for each identified candidate hardware resource. In some examples, calculating the score may be based at least on execution priorities for the machine learning model. In some examples, calculating the score may be based at least on a weighted sum of the execution priorities for each identified candidate hardware resource. Based at least on the scores, the AI inference service, communicatively coupled to the scheduler, may assign (e.g., schedule) the machine learning model to the selected hardware resource for execution of the machine learning model.

In another non-limiting example, systems and methods for allocating ML models to hardware resources available across computing nodes of a distributed cluster are described. In some examples, a scheduler may evaluate metrics of the ML model in order to match the ML model to suitable (e.g., feasible, etc.) hardware resources. In some examples, a scheduler may filter many available hardware resources to only suitable ones, and may score the suitable ones in accordance with a variety of operational priorities. In some examples, based on the scores, the ML model may be assigned to a particular hardware resource (e.g., by a scheduler, an AI inference service, or the like). In some examples, the AI inference service abstracts inner details about hardware resources and runtimes, and provides a common interface for scripts and/or applications to run the ML models.

In this way, systems and methods described herein include an AI inference service communicatively coupled to a scheduler that, in some examples, may efficiently schedule GPUs (or other hardware resources, hardware accelerators, etc.) across these different tasks based on determinations made, for example, by an AI inference service described herein (e.g., make scheduling decisions across various tasks).

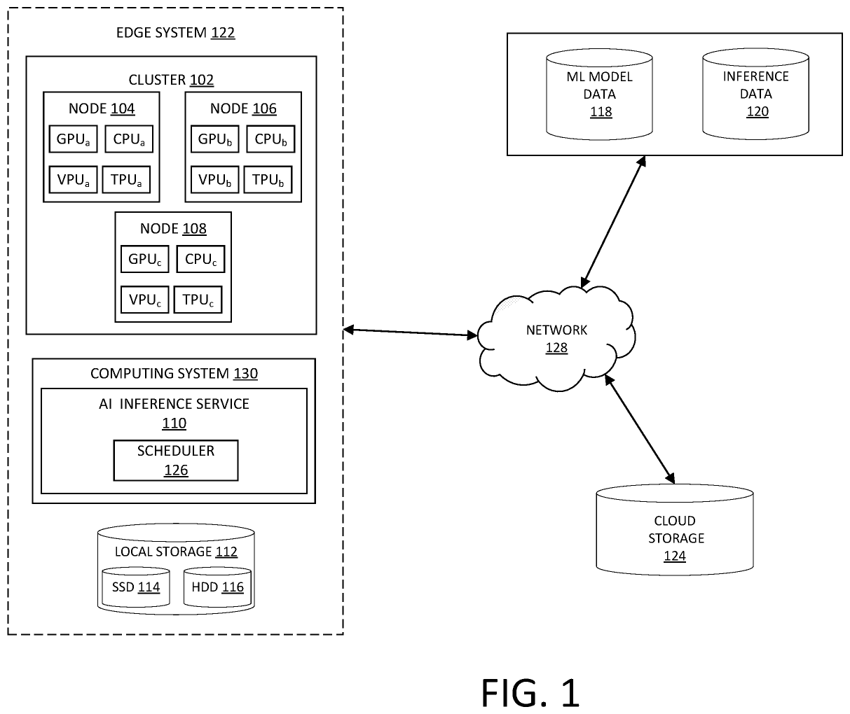

Turning now to FIG. 1, FIG. 1 is a computing system that implements an AI inference service system (e.g., AI inference system 100), in accordance with an embodiment of the present disclosure. It should be understood that this and other arrangements and elements (e.g., machines, interfaces, function, orders, and groupings of functions, etc.) can be used in addition to or instead of those shown, and some elements may be omitted altogether. Further, many of the elements described herein are functional entities that may be implemented as discrete or disturbed components or in conjunction with other components, and in any suitable combination and location. Various functions described herein as being performed by one or more components may be carried out by firmware, hardware, and/or software. For instance, and as described herein, various functions may be carried out by a processor executing instructions stored in memory.

As described herein, AI inference system 100 generally includes an edge system, such as edge system 122, cloud storage, such as cloud storage 124, ML model data 118, and inference data 120. Edge system may include, for example, computing clusters, such as cluster 102, a computing system 130, and local storage, such as local storage 112. Computing system 130 may include AI inference service 110, and AI inference service 110 may include scheduler 126. Local storage 112 may include SSD storage 114 and HDD storage 116. It should be understood that AI inference system 100 shown in FIG. 1 is an example of one suitable architecture for implementing certain aspects of the present disclosure. Additional, fewer, and/or alternative components may be used in other examples.

It should be noted that implementations of the present disclosure are equally applicable to other types of devices such as mobile computing devices and devices accepting gesture, touch, and/or voice input. Any and all such variations, and any combinations thereof, are contemplated to be within the scope of implementations of the present disclosure. Further, although illustrated as separate components of AI inference system 100, any number of components can be used to perform the functionality described herein. Additionally, although illustrated as being a part of edge system 122, the components can be distributed via any number of devices. For example, cluster 102 may be provided by one device, server, or cluster of servers, while AI inference service 110 may be provided by another device, server, or cluster of servers. Moreover, AI inference service 110 may be provided by one device, server, or cluster of servers, while scheduler 126 may be provided via another device, server, or cluster of servers. Additionally, while shown as only one system and/or device, AI inference system 100 may include additional edge systems, devices, and the like.

As shown in FIG. 1, edge system 122, ML model data 118, inference data 120, and cloud storage 124 may communicate with each other, for example, via network 128. Network 128 may be any type of network capable of routing data transmissions from one network device or component (e.g., nodes 104-108, cloud storage 124, ML model data 118, and/or inference data 120) to another. In some examples, the network 128 may be one or more local area networks (LANs), wide area networks (WANs), cellular communications or mobile communications networks, Wi-Fi networks, and/or BLUETOOTH® networks, or combinations thereof. Network 128 may additionally and/or alternatively be a wired network, a wireless network, or a combination thereof. Such networking environments are commonplace in offices, enterprise-wide computer networks, laboratories, homes, educational institutions, intranets, and the Internet. Accordingly, network 128 is not further described herein.

It should be understood that any number of edge systems, devices, computing devices, computing systems, or the like, may be employed within AI inference system 100 and is within the scope of implementations of the present disclosure. In some examples, each may comprise a single device or multiple devices, each having one or more computing nodes with one or more hardware resources, cooperating in a distributed and/or clustered environment. Additionally and/or alternatively, other components not shown may also be included within the network environment.

As described herein, edge system 122 may communicate with and/or have access (via network 128) to at least one data store repository, such as, for example, ML model data 118, inference data 120, and/or cloud storage 124.

As described herein, in some examples, ML model data 118 may be located (e.g., stored) in an edge system of a distributed computing environment system, such as edge system 122 of FIG. 1. However, while shown as remote from the edge system 122 and accessible over network 128, it should be appreciated that in some examples, ML model data 118 and/or inference data 120 may be accessible locally to edge system 122 (e.g., stored at one of the computing nodes in the cluster, or in storage accessible to one of those computing nodes and/or the AI inference service. Additionally, and in some examples, ML model data 118 may be located elsewhere within a distributed computing environment system, such as within a cluster, such as cluster 102, within a node, such as node 104, another edge system (not shown), within local storage of an edge system, such as local storage 112, within cloud storage of a distributed computing environment system, such as cloud storage 124, and the like. For example, ML model data 118 may be local to an edge system of a distributed computing environment system, and/or it may be communicatively coupled to an edge system via a network, such as network 128 of FIG. 1.

In some examples, ML model data 118 may include any data and/or metadata related to machine learning models and/or algorithms. In some examples, ML model data 118 may include multi-layer perceptron model data, decision tree model data, k-means clustering model data, linear regression model data, support vector machine model data, apriori model data, generative adversarial model data, self-trained naïve Bayes classifier model data, Q-learning model data, and the like. In some examples, ML model data 118 may include machine learning models for regression, classification, clustering, and the like.

In some examples, ML model data 118 may additionally and/or alternatively include data and/or metadata associated with machine learning model(s), including supervised learning machine learned models (e.g., classification, regression, etc.), unsupervised learning machine learned models (e.g., dimensionality reduction, clustering, etc.), reinforcement learning machine learned models, semi-supervised learning machine learned models, self-supervised machine learned models, multi-instance learning machine learned models, inductive learning machine learned models, deductive learning machine learned models, transductive learning machine learned models, and the like.

In some examples, ML model data 118 may additionally and/or alternatively include data and/or metadata related to various datasets (including data features), as well as cost function data and loss function data. In some examples, ML model data 118 may include additional and/or alternative data specific to various and respective machine learning models to be placed (e.g., scheduled) on a hardware resource (e.g., hardware accelerator(s)) as described herein.

In some examples, ML model data 118 may additionally and/or alternatively include data and/or metadata associated with characteristics and/or functionalities and/or computational workload associated with running machine learning models described herein. In some examples, ML model data 118 may additionally and/or alternatively include data and/or metadata associated with relevant compute resource metrics required to run a machine learning model as described herein. In some examples, relevant compute resource metrics required to run a machine learning model may include GPU utilization, GPU memory, machine learning model approximated FLOPS requirements, machine learning model memory requirements, CPU utilization, host memory, inference request count, number of kubernetes (k8) pods, inference request latency, or combinations thereof.

In some examples, ML model data 118 may additionally and/or alternatively include data and/or metadata associated with computational abilities and functions of various hardware resources (e.g., accelerators, processing units, etc.) on one or more computing nodes in a clustered computing system described herein. In some examples, the data and/or metadata associated with the computational abilities and functions processing units (or other hardware accelerators) may include graphics processing units (GPUs), tensor processing units (TPUs), video processing units (VPUs), central processing units (CPUs), and the like.

In some examples, ML model data 118 may additionally and/or alternatively include data and/or metadata associated with execution priorities associated with hardware resources and/or nodes described herein. In some examples, the execution priorities may include, but are not limited to, an inference request count on a node in last x hours, number of kubernetes (k8) pods running on a node, number of machine learning models running on a node, free processor memory space, processor utilization (e.g., GPU utilization, CPU utilization, etc.), or combinations thereof.

In some examples, ML model data 118 may additionally and/or alternatively include data and/or metadata associated with a scheduling algorithm (e.g., including identifying and score) used, in some examples, for selecting (assigning, placing, identifying) a hardware resource and/or node (e.g., compute node) on which to place a machine learning model.

In some examples, ML model data 118 may additionally and/or alternatively include machine learning models that are stateless models. In other words, the inference service does not maintain state between inference requests. It solves most of the use cases that use Object Detection, Image classification, etc. In some examples, the machine learning models can run on both CPU and GPU. In some examples, a CPU may be used as a fall back in case GPU is unavailable. In some examples, various classes (e.g., types, etc.) of hardware accelerators and SKU may be sorted based on capacity. In some examples, ML model data 118 may additionally and/or alternatively include data and/or metadata associated with inference rate for one or more ML models. In some examples, ML models described herein may be sorted at least in part by their inference rate.

As described herein, in some examples, inference data 120 may be located (e.g., stored) in an edge system of a distributed computing environment system, such as edge system 100 of FIG. 1. However, it should be appreciated that inference data 120 may be located elsewhere within a distributed computing environment system, such as within a cluster, such as cluster 102, within a node, such as node 104, another edge system, within local storage of an edge system, such as local storage 112, within cloud storage of a distributed computing environment system, such as cloud storage 124, and the like. For example, inference data 120 may be local to an edge system of a distributed computing environment system, and/or it may be communicatively coupled to an edge system via a network, such as network 128 of FIG.

In some examples, inference data 120 may include data and/or metadata associated with AI inference results (e.g., determinations and/or calculations made by AI inference service 110) for determining (e.g., identifying, selecting, etc.) a hardware resource (e.g., hardware accelerator) out of a plurality of hardware resources that a machine learning model may be assigned (e.g., placed, scheduled, etc.), unassigned (e.g., removed, unscheduled, reassigned (e.g., re-placed, rescheduled), and the like. For example, inference data 120 may include data and/or metadata associated with one or more scores calculated using a scoring algorithm for one or more nodes, one or more hardware resources (e.g., accelerators), and the like, associated with scheduling a machine learning model on a hardware resource using an AI inference service, such as AI inference service 110 of FIG. 1. In some examples, inference data 120 may include data and/or metadata associated with a weighted sum of a plurality of execution priorities for a particular node and/or hardware resource.

In some examples, inference data 120 may include data and/or metadata associated with a single hardware resource (e.g., accelerator) on which to place (e.g., schedule) a machine learning model. In some examples, inference data 120 may include data and/or metadata associated with more than one hardware resource (e.g., accelerator) on which to place (e.g., schedule) a machine learning model. In some examples, inference data 120 may include no hardware resources (e.g., accelerator) on which to place (e.g., schedule) a machine learning model).

As described herein, in some examples, cloud storage 124 may be located (e.g., stored) in an edge system of a distributed computing environment system, such as edge system 100 of FIG. 1. However, it should be appreciated that cloud storage 124 may be located elsewhere within a distributed computing environment system, such as within a cluster, such as cluster 102, within a node, such as node 104, another edge system, within local storage of an edge system, such as local storage 112, and the like. For example, cloud storage 124 may be local to an edge system of a distributed computing environment system, and/or it may be communicatively coupled to an edge system via a network as shown, such as network 128 of FIG. 1.

As described herein, in some examples, cloud storage 124 may include data and/or metadata associated with scheduling ML models to hardware resources as described herein. For example, cloud storage 124 may include data and/or metadata associated with machine learning models and/or algorithms, various datasets (including data features), as well as cost function data and loss function data, data specific to various and respective ML models to be placed (e.g., scheduled) on a hardware resources as described herein, characteristics and/or functionalities and/or computational workload associated with running ML models described herein, relevant compute resource metrics required to run a machine learning model as described herein, computational abilities and functions of various hardware resources (e.g., accelerators, processing units, etc.) on one or more computing nodes in a clustered computing system described herein, execution priorities associated with hardware resources and/or nodes described herein, a scheduling algorithm used, in some examples, for selecting (assigning, placing, identifying) a hardware resource and/or node (e.g., compute node) on which to place a machine learning model, and the like.

In some examples, cloud storage 124 may additionally and/or alternatively include data and/or metadata associated with AI inference results (e.g., determinations made by AI inference service 110) for determining (e.g., identifying, selecting, etc.) a hardware resource (e.g., hardware accelerator) out of a plurality of hardware resources that a machine learning model may be assigned (e.g., placed, scheduled, etc.), unassigned (e.g., removed, unscheduled, reassigned (e.g., re-placed, rescheduled), and the like. Cloud storage 124 may additionally and/or alternatively, in some examples, include data and/or metadata associated with one or more scores calculated using a scoring algorithm for one or more nodes, one or more hardware resources (e.g., accelerators), and the like, associated with scheduling a machine learning model on a hardware resource using an AI inference service.

Cloud storage 124 may additionally and/or alternatively include one or more storage servers that may be stored remotely from nodes 104-108 and accessed via network 128. Cloud storage 124 may generally include any type of storage device, such as HDDs, SSDs, or optical drives.

In implementations of the present disclosure, ML model data 118, inference data 120, and/or cloud storage 124 may each be configured to be retrievable (and/or searchable) for the data and metadata stored in ML model data 118, inference data 120, and/or cloud storage 124. It should be understood that the information stored in ML model data 118, inference data 120, and/or cloud storage 124 may include any information relevant scheduling ML models on hardware resources described herein. As should be appreciated, data and metadata stored in ML model data 118, inference data 120, and/or cloud storage 124 may be added, removed, replaced, altered, augmented, etc. at any time, with different and/or alternative data. It should further be appreciated that each of ML model data 118, inference data 120, and/or cloud storage 124 may be updated, repaired, taken offline, etc. at any time without impacting the other data stores. It should further be appreciated that while three data stores are illustrated, additional and/or fewer data stores may be implemented and still be within the scope of this disclosure.

Information stored in ML model data 118, inference data 120, and/or cloud storage 124 may be accessible to any component of AI inference system 100. The content and the volume of such information are not intended to limit the scope of aspects of the present technology in any way. Further, ML model data 118, inference data 120, and/or cloud storage 124 may each be single, independent components (as shown) or a plurality of storage devices, for instance, a database cluster, portions of which may reside in association with edge system 122, an external user device (not shown) an external computing device (not shown), another edge system (not shown), and/or any combination thereof. Additionally, ML model data 118, inference data 120, and/or cloud storage 124 may include a plurality of unrelated data repositories or sources within the scope of embodiments of the present technology. ML model data 118, inference data 120, and/or cloud storage 124 may be updated at any time, including an increase and/or decrease in the amount and/or types of stored data and/or metadata. As described herein, ML model data 118, inference data 120, and/or cloud storage 124 may include but are not limited to, local physical memory storage, network storage, distributed storage, disk storage, or combinations thereof.

Examples described herein may include edge systems, such as edge system 122. In some examples, an “edge” and/or edge system 122 may be implemented using a cluster of computing nodes. Each of the computing nodes may have one or more hardware resources, such as hardware classes (e.g., GPUs, CPUs, etc.). In some examples, a cluster may not be present, and one or more computing nodes may be present which may not form a cluster. Edge system 122 may provide an AI inferencing service that is capable of executing inference operations in accordance with one or more machine learning models that may be supported by the service. As illustrated, edge system 122 may include clusters, such as cluster 102, an AI inference service, such as AI inference service 110, and local storage, such as local storage 112. Cluster 102 my may include nodes 104, 106, and 108. Each of nodes 104, 106, and 108 may include one or more hardware resources. For example, node 104 may include GPUa, CPUa, VPUa, and/or TPUa. Node 106 may include GPUb, CPUb, VPUb, and/or TPUb. Node 108 may include GPUc, CPUc, VPUc, and/or TPUc. AI inference service 110 may include scheduler 126. Local storage 112 may include SSD storage 114 and HDD storage 116.

As described herein, edge system 122 may include local storage 112. Local storage 112 may include, for example, one or more solid state drives (SSD) such as SSD storage 114 and/or one or more hard disk drives (HDD), such as HDD storage 116. In some examples, local storage 112 may be directly coupled to, included in, and/or accessible by a respective computing node, such as nodes 104-108, without communicating via network 128. In some examples, local storage 112, including SSD storage 114 and/or HDD storage 116 may include identical, similar, additional, and/or alternative data and/or metadata as that of ML model data 118, inference data 120, and/or cloud storage 124. In some examples, local storage 112, including SSD storage 114 and/or HDD storage 116 may include any data and/or metadata associated with scheduling a machine learning model to run on a hardware resource in an edge system using an AI inference service.

Examples described herein may include clusters, such as cluster 102 of FIG. 1. Clusters as described herein may comprise a group of interconnected computers that may work together and/or individually to perform computationally intensive tasks. In some examples, the interconnected computers may comprise one or more nodes, such as nodes 104-108. In some examples, nodes 104-108 are computing nodes.

In some examples, each of nodes 104, 106, and 108 may include one or more hardware resources on which computation may take place (e.g., running a machine learning model). For example, node 104 may include GPUa, CPUa, VPUa, and/or TPUa. Node 106 may include GPUb, CPUb, VPUb, and/or TPUb. And, node 108 may include GPUc, CPUc, VPUc, and/or TPUc. In some examples, GPUa, CPUa, VPUa, and/or TPUa, GPUb, CPUb, VPUb, and/or TPUb, and/or GPUc, CPUc, VPUc, and/or TPUc may be candidate hardware resources as described herein. In some examples nodes 104-108 are connected to one another within cluster 102 by high-speed, low latency networks, which in some examples, helps support parallel operations across nodes.

In some examples, GPUs and/or additional and/or alternative hardware resources may be used for multiple purposes on edge, e.g., edge system 122 of FIG. 1. Systems and methods described herein may use GPUs (and other hardware resources) to accelerate machine learning models using an AI Inferencing service (e.g., AI inference service 110 of FIG. 1), encode (decode) video formats and use it to run customer application containers. In some examples, such hardware resources are scarce and expensive, but provides significant improvements to latencies for the machine learning workloads described herein.

In some examples, each of nodes 104-108 may be a computing device for hosting a virtualized computing environment including one or more virtual machines (VMs) and/or one or more containers in the distributed computing environment system of FIG. 1. In some examples, nodes 104-108 may each be, for example, a server computer, a laptop computer, a desktop computer, a tablet computer, a smart phone, or any other type of computing device. In some examples, nodes 104-108 may each include one or more physical computing components, such as processors (e.g., GPUa, CPUa, VPUa, and/or TPUa, and the like) as described herein.

While not shown, in some examples, computing nodes, such as nodes 104-108 may be configured to execute a hypervisor, a controller VM, one or more user VMs, one or more containers and/or one or more virtualization managers. The user VMs may be virtual machine instances executing on nodes 104-108. The user VMs may share a virtualized pool of physical computing resources such as physical processors (e.g., hardware resources, hardware accelerators, etc.) and storage (e.g., local storage 112, cloud storage 124, ML model data 118, inference data 120, and the like). The user VMs may each have their own operating system, such as Windows or Linux. Generally any number of user VMs may be implemented. User VMs may generally be provided to execute any number of applications which may be desired by a user, a client, an administrator, etc.

As should be appreciated, while 3 nodes are illustrated in cluster 102, additional, fewer, and/or alternative nodes are contemplated to be within the scope of the disclosure. Additionally, and as should further be appreciated, while each of node 104-108 comprise four hardware resources (e.g., GPU, CPU, VPU, and TPU), nodes comprising additional, fewer, and/or alternative hardware resources are contemplated to be within the scope of the disclosure. As should further be appreciated, while each of nodes 104-108 are located in edge system 122, additionally and/or alternative nodes may be located remote from edge system 122. For example, additional and/or alternative nodes accessible by AI inference service 110 may be located in a cloud, another edge system, or the like.

Examples described herein include computing system 130, which may include AI inference services, such as AI inference service 110. AI inference service 110 may include scheduler 126. Computing system 130 described herein may include any type of computing system (e.g., device, etc.) capable of running AI inference services and/or schedulers, via processors and/or memory, as described herein. While shown as located in computing system 130, AI inference service 110 may, in some examples, be located in an edge system of a distributed computing environment system, such as edge system 122 of AI inference system 100 of FIG. 1. However, it should be appreciated that AI inference service 110 may be located elsewhere within a distributed computing environment system, such as within a cluster, such as cluster 102, within a node, such as node 104, another edge system, a computing device (not shown) of AI inference system 100, and the like. For example, AI inference service 110 may be local to an edge system of a distributed computing environment system, or AI inference service 110 may be communicatively coupled to an edge system via a network, such as network 128 of FIG. 1.

While not shown in FIG. 1, AI inference service 110 may, in some examples, include one or more processors and/or memory storing executable instructions for determining where (e.g., on which hardware resource) to place (e.g., schedule, assign, etc.) a machine learning model as described herein (e.g., such as one or more processors and/or memory of computing system 130). While not shown, any kind and/or number of processor may be present, including one or more central processing unit(s) (CPUs), graphics processing units (GPUs), other computer processors, mobile processors, digital signal processors (DSPs), microprocessors, computer chips, and/or processing units configured to execute machine language instructions and process data, such as executable instructions for scheduling machine learning models on hardware resources as described herein. Additionally, any type or kind of memory may be present (e.g., read only memory (ROM), random access memory (RAM), solid-state drive (SSD), and secure digital card (SD card)). The memory and the processor may be in communication with each other. The memory may be non-transitory.

Scheduler 126 may, in some examples, be located in an edge system of a distributed computing environment system, such as in AI inference service 110 of AI inference system 100 of FIG. 1. However, it should be appreciated that scheduler 126 may be located elsewhere within a distributed computing environment system, such as within a cluster, such as cluster 102, within a node, such as node 104, another edge system, and the like. For example, scheduler 126 may be local to an edge system of a distributed computing environment system, or it may be communicatively coupled to an edge system via a network, such as network 128 of FIG. 1.

While not shown in FIG. 1, scheduler 126 may, in some examples, include one or more processors and/or memory storing executable instructions for placing (e.g., assigning, scheduling, selecting, etc.) the ML model on a hardware resource based on, in some examples, at least a determination made by AI inference service 110. In some examples, scheduler 126 may additionally and/or alternatively reassign and/or reschedule, and/or unassigned and/or de-schedule a ML model on a hardware resource based at least on a determination made by AI inference service 110 as described herein. While not shown, any kind and/or number of processor may be present, including one or more central processing unit(s) (CPUs), graphics processing units (GPUs), other computer processors, mobile processors, digital signal processors (DSPs), microprocessors, computer chips, and/or processing units configured to execute machine language instructions and process data, such as executable instructions for scheduling machine learning models on hardware resources as described herein. Additionally, any type or kind of memory may be present (e.g., read only memory (ROM), random access memory (RAM), solid-state drive (SSD), and secure digital card (SD card)). The memory and the processor may be in communication with each other. The memory may be non-transitory.

Operationally, and as described herein, AI inference service 110 may be configured to, utilizing a processor (coupled to memory) and executing executable instructions, receive a request to execute a machine learning model on a hardware resource of an edge system. In some examples, the request may be sent by a user, administrator, client, end-user, customer, and the like, of AI inference system 100. In some examples, the machine learning model may be associated with compute resource metrics indicative of the computational workload required to execute the machine learning model on a hardware resource. In some examples, the compute resource metrics may include but are not limited to graphics processing unit (GPU) utilization, GPU memory, machine learning model approximated FLOPS requirements, machine learning model memory requirements, central processing unit (CPU) utilization, host memory, inference request count, number of kubernetes (k8) pods, inference request latency, or combinations thereof.

In some examples, the request may include a request to execute a single machine learning model. In some examples, the request may include a request to execute more than one machine learning model. In some examples, an end user can upload multiple machine learning models. In some examples, AI inferencing service 110 may efficiently execute the machine learning models on one and/or more than one hardware resource and/or node. In a multi node edge, such as edge system 122 of FIG. 1, when the end user uploads a machine learning model (e.g., to ML model data 118), an inference master (e.g., AI inference service 110) may determine a hardware resource placement decision, such that the hardware resource utilization is efficient across the cluster (e.g., cluster 102 of edge system 122 of FIG. 1).

In some examples, determining the computational workload of a machine learning model may be based on collecting relevant compute resource metrics required to run the machine learning model. In some examples, a scraper (not shown) communicatively coupled to AI inference service 110 may collect the relevant compute resource metrics. The relevant compute resource metrics may include, but are not limited to, GPU utilization, GPU memory, machine learning model approximated floating point operations per second (FLOPS) requirements, machine learning model memory requirements, CPU utilization, host memory, inference request count, number of k8 pods, inference request latency, any additional and/or alternative suitable metrics, and/or combinations thereof. In some examples, the scraped metrics may be stored in a database or data store, such as, for example, a Prometheus database, cloud storage (e.g., cloud storage 124 of FIG. 1), local storage (e.g., local storage 112), or other suitable storage.

In some examples, and as should be appreciated, there may be different types of computational workloads described herein where hardware resources are used. For example, computational workloads may include customer workloads, edge-in-built-service workloads, or combinations thereof. In some examples, customer workloads may be containers uploaded by a customer. For example, in the case of Customer A and Customer B, they, in some examples, may use a container with a GPU (or other hardware resource) to run their machine learning model. In some examples, edge-in-built-service workloads may be inbuilt services like AI Inferencing service 110. For example, a customer may use an AI inferencing service with GPU (and/or other hardware accelerators) to run their machine learning model.

In some examples, to separate GPUs (and/or other hardware accelerators) between these two workloads, systems and methods described herein may provide an option in a user interface (e.g., UI, GUI, etc.) to statically assign a number of GPUs (and/or other hardware accelerators) to Edge in built service workloads. The rest of the GPUs (and/or other hardware accelerators) on the edge may be floating GPUs (and/or other hardware accelerators) that may be used for customer workloads.

The floating GPUs (and/or other hardware accelerators, resources, etc.) may be assigned to any customer container. In some examples, it may be explicitly selected when the customer is creating a kubernetes (K8) application container. Systems and methods described herein, in some examples, may schedule the floating GPUs (and/or other hardware accelerators) using a scheduler and an AI Inference engine/service.

AI inference service 110 may further be configured to, utilizing a processor (coupled to memory) executing executable instructions, identify (e.g., filter) candidate hardware resources for executing the machine learning model. In some examples, the hardware resources may include but are not limited to GPUs, CPUs, tensor processing units (TPUs), video processing units (VPUs), other processing units, other hardware accelerators, and/or combinations thereof.

In some examples, the identification may be resource-based, topology-based, or combinations thereof. In some examples, the identification may be resource-based, such as the presence of specific processors, whether the free memory available on the specific processors is greater than the machine learning model's memory requirement, and whether the specific processor's cores can accommodate running a new machine learning model without degrading the performance of models already running on the specific processor. In some examples, the identification may be topology-based, such as based on node affinity and/or rack-awareness (e.g., in the case of clustered systems) in the clustered computing system. In some examples, the identification may be made to place the ML model at a node positioned in a rack where the total power usage of the rack is below a threshold. In some examples, the identification may be made to place the ML model at a node located in a protected location (e.g., physically or otherwise, away from an entrance, at a certain height from the ground, etc.). In some examples, node affinity may include a set of rules that limits which nodes an ML model may be eligible to be scheduled on. In some examples, rack-awareness may include making the system aware of which node(s) is part of which rack within a cluster, and/or how each node is connected to each other within the cluster.

In some examples, the identification may be based at least in part on analyzing compute resource metrics of the machine learning model to determine an approximate compute resource need to run the machine learning model. In some examples, analyzing compute resource metrics (e.g., approximated memory and FLOPS requirements) may be based at least in part on analyzing a deep learning model graph structure including what operations are performed on each graph node of a plurality of graph nodes. In some examples, analyzing the compute resource metrics of the machine learning model may be based at least on determining a compute resource expectation for the machine learning model. In some examples, the identification may be based at least in part on node affinity of a node of the plurality of nodes of the clustered computing system, rack-awareness in the clustered computing system, or combinations thereof.

In some examples, the identification may be informed by qualities and/or characteristics of the machine learning model. In some examples, the allocating (e.g., scheduling) of a machine learning model to hardware is based on an AI inference service comparing the computational workload of a machine learning model, with the computational abilities and functions of various classes of available hardware (e.g., processing units) on a single computing node in a clustered computing system. Example processing units (or other hardware accelerators) may include graphics processing units (GPUs), tensor processing units (TPUs), video processing units (VPUs), central processing units (CPUs), and the like.

In some examples, the allocating (e.g., scheduling) of a machine learning model to hardware is based on an AI inference service comparing the computational workload of a machine learning model, with the computational abilities and functions of local nodes and/or nodes located in the cloud.

In some examples, the identification may be based on first analyzing GPUs of nodes of the plurality of nodes in the clustered computing system. In the case where no GPU of a computing node is capable of running the machine learning model with a GPU, the identification may be executed again, but analyzing CPUs (or other types of hardware resources, accelerators, or the like), instead. As such, in some examples, the system may analyze hardware resources in a particular order. In some examples, the system may analyze all available hardware resources simultaneously. In examples, the order in which hardware resources are analyzed may be hard coded. In some examples, AI inference system 100, and/or components of AI inference system, may automatically determine the order in which hardware resources are analyzed. In some examples, a user, customer, client, administrator, etc. of AI inference system 100 may determine the order in which hardware resources are analyzed.

AI inference service 110 may further be configured to, utilizing a processor (coupled to memory) executing executable instructions, calculate (e.g., determine) a score for each identified candidate hardware resource of the identified candidate hardware resources. In some examples, the calculating is based at least on execution priorities for the machine learning model. As described herein, execution priorities may include, but are not limited to, inference request count on a hardware resource in last x hours (less is better), number of kubernetes (k8) pods running on that node (less is better), number of machine learning models running on a hardware resource (less is better), free processor memory space (more is better), and processor utilization (e.g., GPU utilization, CPU utilization, etc.) (more is better). In some examples, the execution priorities comprise per-node per-time period inference request counts, per-node number of kubernetes (k8) pods running, per-node machine learning models running, free processor memory space, processor utilization, or combinations thereof. In some examples, the weights are calculated through experiments (or by feeding experimental data to logistic regression model). As should be appreciated, this list is not an exhaustive list of priorities, and other priorities suitable for scoring are contemplated to be within the scope of this disclosure

In some examples the weighted sum equation is the following:

Nₛ=sum(Pᵢ*Wᵢ) Equation (1)

Where Pi is an initial execution priority, Wi is an initial execution priority weight, and Ns is a score associated with the initial execution priority and initial execution priority weight for an identified candidate hardware resource.

In some examples, the calculating may be based at least on a weighted sum of the execution priorities for each of the identified candidate hardware resources.

In some examples, scheduler 126 may be configured to, utilizing a processor (coupled to memory) executing executable instructions, assign (e.g., schedule, place, etc.) the machine learning model to one of the identified candidate hardware resources based at least on the calculating.

In some examples, AI inference service 110 may further be configured to, utilizing a processor (coupled to memory) executing executable instructions, execute the machine learning model once it is assigned (e.g., scheduled, placed, etc.) to one of the identified candidate hardware resources.

In some examples, when AI inference service 110 receives the request, it forwards that request to the node (and/or hardware resource) of the clustered computing system selected to run the machine learning model (e.g., for, in some examples, load balancing purposes). In some examples, if the queries per second for the machine learning model is high, then the scheduler may replicate the machine learning model on to another node (and/or hardware resource), thus when routing the request, AI inference service 110 may, in some examples, choose multiple nodes. In some examples, if the edge nodes (and/or hardware resources) are busy (and/or maxed out of their compute capacities), AI inference service 110 may forward the request to a cloud instance of the node (and/or hardware resource).

While certain components are shown in FIG. 1, other additional, fewer, and/or alternative components may be included in the distributed computing environment system, such as, for example, additional, fewer, or alternative edge systems, databases and/or other storage, ML model data, and/or inference results/data. Such additional, fewer, and/or alternative components are contemplated to be within the scope of this disclosure.

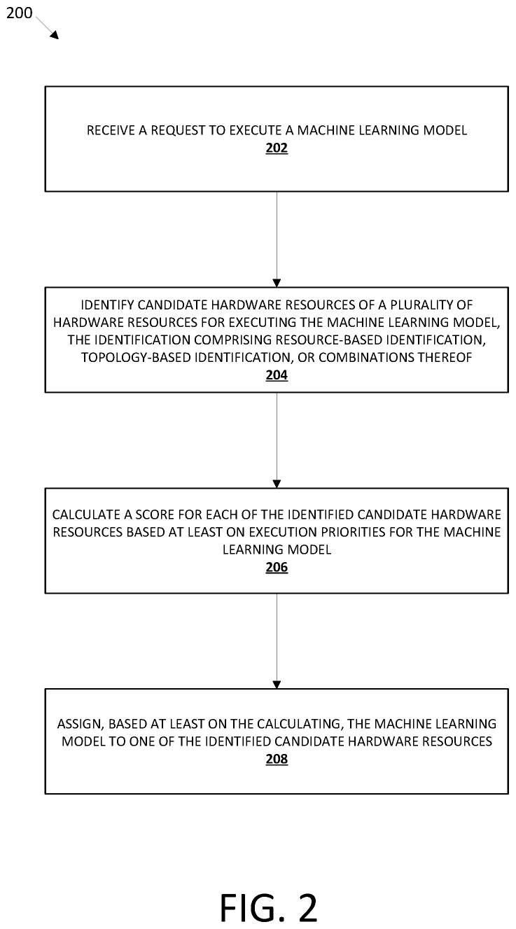

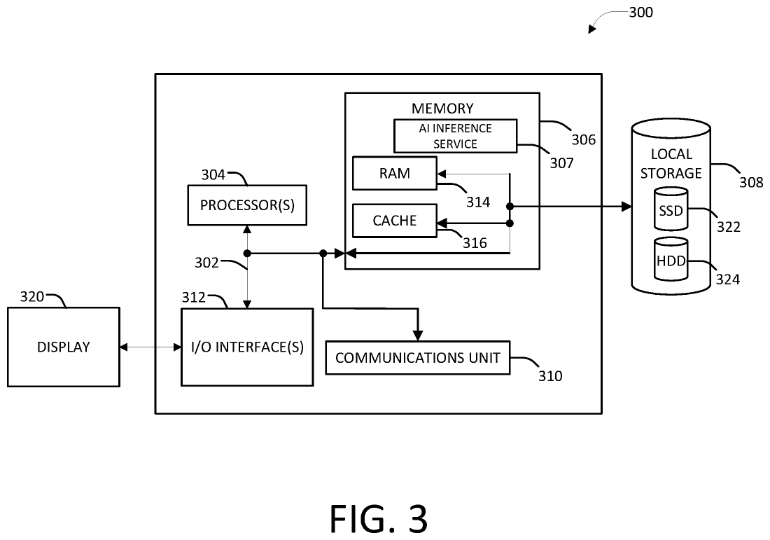

FIG. 2 is a flow diagram of a method 200 for hardware resource scheduling using an AI inference service, arranged in accordance with examples described herein. This method 200 may be implemented, for example, using system 100 of FIG. 1 (e.g., AI inference service 110, scheduler 126, and/or other components), and/or computing node 300 of FIG. 3.

The method 200 includes receiving a request to execute a machine learning model in block 202, identifying candidate hardware resources of a plurality of hardware resources for executing the machine learning model, the identification comprising resource-based identification, topology-based identification, or combinations thereof in block 204, calculating a score for each of the identified candidate hardware resources based at least on execution priorities for the machine learning model in block 206, and, assigning, based at least on the calculating, the machine learning model to one of the identified candidate hardware resources in block 208.

Block 202 recites receiving a request to execute a machine learning model.

In some examples, the request may be sent by a user, administrator, client, end-user, customer, and the like, of AI inference system 100. In some examples, the machine learning model may be associated with compute resource metrics indicative of the computational workload required to execute the machine learning model on a hardware resource. In some examples, the compute resource metrics may include but are not limited to graphics processing unit (GPU) utilization, GPU memory, machine learning model approximated FLOPS requirements, machine learning model memory requirements, central processing unit (CPU) utilization, host memory, inference request count, number of kubernetes (k8) pods, inference request latency, or combinations thereof.

In some examples, the request may include a request to execute a single machine learning model. In some examples, the request may include a request to execute more than one machine learning model. In some examples, an end user can upload multiple machine learning models. In some examples, AI inferencing service 110 may efficiently execute the machine learning models on one and/or more than one hardware resource and/or node.

Block 204 recites identifying candidate hardware resources of a plurality of hardware resources for executing the machine learning model, the identification comprising resource-based identification, topology-based identification, or combinations thereof.

In some examples, the identification may be resource-based, such as the presence of specific processors, whether the free memory available on the specific processors is greater than the machine learning model's memory requirement, and whether the specific processor's cores can accommodate running a new machine learning model without degrading the performance of models already running on the specific processor. In some examples, the identification may be topology-based, such as based on node affinity and/or rack-awareness in the clustered computing system.

In some examples, the identification may be based at least in part on analyzing compute resource metrics of the machine learning model to determine an approximate compute resource need to run the machine learning model. In some examples, analyzing compute resource metrics (e.g., approximated memory and FLOPS requirements) may be based at least in part on analyzing a deep learning model graph structure including what operations are performed on each graph node of a plurality of graph nodes. In some examples, analyzing the compute resource metrics of the machine learning model may be based at least on determining a compute resource expectation for the machine learning model. In some examples, the identification may be based at least in part on node affinity of a node of the plurality of nodes of the clustered computing system, rack-awareness in the clustered computing system, or combinations thereof.

Block 206 recites calculating a score for each of the identified candidate hardware resources based at least on execution priorities for the machine learning model.

In some examples, the calculating is based at least on execution priorities for the machine learning model. As described herein, execution priorities may include, but are not limited to, inference request count on a hardware resource in last x hours (less is better), number of kubernetes (k8) pods running on that node (less is better), number of machine learning models running on a hardware resource (less is better), free processor memory space (more is better), and processor utilization (e.g., GPU utilization, CPU utilization, etc.) (more is better). In some examples, the execution priorities comprise per-node per-time period inference request counts, per-node number of kubernetes (k8) pods running, per-node machine learning models running, free processor memory space, processor utilization, or combinations thereof. In some examples, the weights are calculated through experiments (or by feeding experimental data to logistic regression model).

Block 208 recites assigning, based at least on the calculating, the machine learning model to one of the identified candidate hardware resources.

FIG. 3 is an example block diagram of components of a computing node 300, arranged in accordance with examples described herein. It should be appreciated that FIG. 3 provides only an illustration of one implementation and does not imply any limitations with regard to the environments in which different embodiments may be implemented. Many modifications to the depicted environment may be made. The computing node 300 may implement as at least part of the AI inference system 100 of FIG. 1, or any other computing device or part of any other system described herein. In some examples, the computing node 300 may be a standalone computing node or part of a cluster of computing nodes configured to host AI inference service 307 (e.g., AI inference service 110 of FIG. 1). Additionally and/or alternatively to hosting AI inference service 307 (e.g., AI inference service 110 of FIG. 1), the computing node 300 may be included as at least part of edge system 122, as described with reference to FIG. 1 and configured to host one or more clusters, nodes, and/or storage (e.g., cluster 102, nodes 104, 106, and/or 108, and/or local storage 112.

The computing node 300 includes a communications fabric 302, which provides communications between one or more processor(s) 304, memory 306, local storage 308, communications unit 310, and I/O interface(s) 312. The communications fabric 302 can be implemented with any architecture designed for passing data and/or control information between processors (such as microprocessors, communications and network processors, etc.), system memory, peripheral devices, and any other hardware components within a system. For example, the communications fabric 302 can be implemented with one or more buses.

The memory 306 and the local storage 308 may be computer-readable storage media. In this embodiment, the memory 306 may include random access memory RAM 314 and cache 316. In general, the memory 306 can include any suitable volatile or non-volatile computer-readable storage media. In an embodiment, the local storage 308 includes an SSD 322 and an HDD 324.

Various computer instructions, programs, files, images, etc. may be stored in local storage 308 for execution by one or more of the respective processor(s) 304 via one or more memories of memory 306. In some examples, local storage 308 includes a magnetic HDD 324. Alternatively, or in addition to a magnetic hard disk drive, local storage 308 can include the SSD 322, a semiconductor storage device, a read-only memory (ROM), an erasable programmable read-only memory (EPROM), a flash memory, or any other computer-readable storage media that is capable of storing program instructions or digital information.

The media used by local storage 308 may also be removable. For example, a removable hard drive may be used for local storage 308. Other examples include optical and magnetic disks, thumb drives, and smart cards that are inserted into a drive for transfer onto another computer-readable storage medium that is also part of local storage 308.

In some examples, the local storage may be configured to store an AI inference service 307 (e.g., AI inference service 110 of FIG. 1) that is configured to, when executed by the processor(s) 304, provide hardware resource scheduling functionality for scheduling machine learning models to hardware resources in a clustered computing system.

Communications unit 310, in these examples, provides for communications with other data processing systems or devices. In these examples, communications unit 310 includes one or more network interface cards. Communications unit 310 may provide communications through the use of either or both physical and wireless communications links.

I/O interface(s) 312 allows for input and output of data with other devices that may be connected to computing node 300. For example, I/O interface(s) 312 may provide a connection to external device(s) 318 (not shown) such as a keyboard, a keypad, a touch screen, and/or some other suitable input device. External device(s) 318 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 308 via I/O interface(s) 312. I/O interface(s) 312 may also connect to a display 320.

Display 320 provides a mechanism to display data to a user and may be, for example, a computer monitor. In some examples, a GUI associated with the AI inference service 307 (e.g., AI inference service 110 of FIG. 1) may be presented on the display 320.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

From the foregoing it will be appreciated that, although specific embodiments of the disclosure have been described herein for purposes of illustration, various modifications may be made without deviating from the spirit and scope of the disclosure. Thus, the disclosure is not limited to the examples and designs described herein except as by the appended claims, and is to be accorded the broadest scope consistent with the principles and novel features disclosed herein.

What is claimed is:

1. At least one non-transitory computer readable medium encoded with instructions which, when executed, cause a system to perform actions comprising:
receiving a request to execute a machine learning model;
identifying candidate hardware resources for executing the machine learning model;
calculating a score for each identified candidate hardware resource of the identified candidate hardware resources based at least on execution priorities for the machine learning model; and
assigning the machine learning model to one of the identified candidate hardware resources based at least on the calculating.

2. The non-transitory computer readable medium of claim 1, the actions further comprising:
identifying based at least in part on analyzing compute resource metrics of the machine learning model to determine an approximate compute resource need to run the machine learning model.

3. The non-transitory computer readable medium of claim 2, the actions further comprising:
analyzing compute resource metrics based at least in part on analyzing a deep learning model graph structure including what operations are performed on each graph node of a plurality of graph nodes.

4. The non-transitory computer readable medium of claim 1, the actions further comprising:
identifying based at least in part on node affinity of a node of the plurality of nodes of a clustered computing system, rack-awareness in the clustered computing system, or combinations thereof.

5. The non-transitory computer readable medium of claim 1, the actions further comprising:
calculating based at least on a weighted sum of the execution priorities for each of the identified candidate hardware resources.

6. The non-transitory computer readable medium of claim 5, wherein the execution priorities comprise per-node per-time period inference request counts, per-node number of kubernetes (k8) pods running, per-node machine learning models running, free processor memory space, processor utilization, or combinations thereof.

7. The non-transitory computer readable medium of claim 1, the actions further comprising:
assigning based at least on compute resource metrics for the machine learning model.

8. The non-transitory computer readable medium of claim 1, wherein the clustered computing environment is a multi-node edge.

9. A method comprising:
identifying candidate hardware resources of a plurality of hardware resources for executing a machine learning model, the identification comprising resource-based identification, topology-based identification, or combinations thereof;
calculating a score for each of the identified candidate hardware resources based at least on execution priorities for the machine learning model; and
assigning, based at least on the calculating, the machine learning model to one of the identified candidate hardware resources.

10. The method of claim 9, wherein the identified candidate hardware resources are identified from the plurality of hardware resources of a clustered computing system comprising a plurality of nodes.

11. The method of claim 10, wherein each node of the plurality of nodes of the clustered computing system comprises at least one hardware resource of the plurality of hardware resources.

12. The method of claim 9, wherein the identifying further comprises analyzing compute resource metrics of the machine learning model to determine a compute resource expectation for the machine learning model.

13. The method of claim 12, wherein analyzing compute resource metrics is based at least in part on analyzing a deep learning model graph structure including operations performed on each graph node of a plurality of graph nodes.

14. The method of claim 9, wherein the identifying is based at least on node affinity of a node of a plurality of nodes of a clustered computing system, rack-awareness in the clustered computing system, or combinations thereof.

15. The method of claim 9, wherein the calculating is based at least on a weighted sum of the execution priorities for each of the identified candidate hardware resources.

16. The method of claim 9, wherein the execution priorities comprise per-node per-time period inference request counts, per-node number of kubernetes (k8) pods running, per-node machine learning models running, free processor memory space, processor utilization, or combinations thereof.

17. The method of claim 9, wherein the assigning is based at least on compute resource metrics for the machine learning model.

18. The method of claim 12, wherein the compute resource metrics comprise graphics processing unit (GPU) utilization, GPU memory, machine learning model approximated FLOPS requirements, machine learning model memory requirements, central processing unit (CPU) utilization, host memory, inference request count, number of k8 pods, inference request latency, or combinations thereof.

19. The method of claim 9, wherein a hardware resource of the multiple hardware resources comprises GPUs, CPU, tensor processing units (TPUs), video processing units (VPUs) other processing units, or combinations thereof.

20. The method of claim 15, wherein the assigning is further based at least on a comparison between a determined approximate compute resource need to run the machine learning model, and the weighted sum of the execution priorities for each of the identified candidate hardware resources.

21. A system comprising:
a plurality of nodes, each having at least one of a plurality of hardware resources, the plurality of nodes configured to form a cluster of a clustered computing system;
an artificial intelligence (AI) inference service, in communication with the plurality of nodes, configured to execute a machine learning model;
a scheduler, communicatively coupled to the AI inference service, configured to select at least one of the plurality of hardware resources for the AI inference service, the selection based at least on characteristics of the hardware resources, characteristics of the machine learning model, or combinations thereof; and
the scheduler further configured to, based at least in part on the selection, assign the machine learning model to a selected one of the plurality of hardware resources for execution of the machine learning model.

22. The system of claim 21, wherein the selection is based at least on identifying, by the AI inference service, the plurality of hardware resources based at least in part on analyzing compute resource metrics of the machine learning model to determine an approximate compute resource need to run the machine learning model.

23. The system of claim 22, wherein analyzing compute resource metrics is based at least in part on analyzing a deep learning model graph structure including what operations are performed on each graph node of a plurality of graph nodes.

24. The system of claim 22, wherein the selection, by the AI inference service, is further based at least in part on node affinity of a node of the plurality of nodes of the clustered computing system, rack-awareness in the clustered computing system, or combinations thereof.

25. The system of claim 22, wherein the selection, by the AI inference service, is further based on calculating a score for each of the at least one of the plurality of hardware resources based at least in part on a weighted sum of execution priorities for each of the at least one of the plurality of hardware resources.

26. The system of claim 25, wherein the execution priorities comprise per-node per-time period inference request counts, per-node number of kubernetes (k8) pods running, per-node machine learning models running, free processor memory space, processor utilization, or combinations thereof.

27. The system of claim 21, wherein the scheduler is further configured to schedule the machine learning model to the selected at least one of the plurality of hardware resources based at least in part on compute resource metrics for the machine learning model.

28. The system of claim 25, wherein the scheduler is further configured to schedule the machine learning model to the selected at least one of the plurality of hardware resources based at least in part on a comparison between a determined approximate compute resource need to run the machine learning model, and the weighted sum of the execution priorities for each identified candidate hardware resource.
